(19) United States
(12) Patent Application Publication
(10) Pub. No.: US 2016/0351137 A1
(43) Pub. Date: Dec. 1, 2016

(54) DISPLAY DEVICE

(71) Applicant: Samsung Display Co. Ltd., Yongin-city (KR)

(72) Inventors: Hyun Sup LEE, Hwaseong-si (KR); Jun Ho SONG, Seongnam-si (KR); Jung Hun NOH, Yongin-si (KR); Keun Kyu SONG, Seoul (KR)

(21) Appl. No.: 14/982,186

(22) Filed: Dec. 29, 2015

(30) Foreign Application Priority Data
May 27, 2015 (KR) 10-2015-0073686

(51) Int. Cl. G09G 3/36

(52) U.S. Cl. CPC G09G 3/3607; G09G 3/3614; G09G 3/3696; G09G 3/3648; G09G 3/3688; G09G 2300/0452

(57) ABSTRACT

A display device includes a first gate line extending in a first direction, a first pixel column group connected to the first gate line and alternately receiving data voltages with a first polarity pattern and data voltages with a second polarity pattern, which is an inverted polarity pattern of the first polarity pattern, at an interval of a unit of a frame, and a plurality of data lines respectively connected to a plurality of pixels included in the first pixel column group, wherein each of the pixels includes a first sub-pixel to which a first voltage is applied and a second sub-pixel to which a second voltage, which is lower than the first voltage, is applied and a maximum width, in the first direction, of the first sub-pixel is greater than a maximum width, in the first direction, of the second sub-pixel.

This application claims priority to Korean Patent Application No. 10-2015-0073686 filed on May 27, 2015, and all the benefits accruing therefrom under 35 U.S.C. §119, the content of which in its entirety is incorporated herein by reference.

### BACKGROUND

1. Field

The invention relates to a display device.

2. Description of the Related Art

Liquid crystal display (“LCD”) devices having thin profiles, light weight, and low power consumption have been used in various electronic devices such as notebook computers, office automation devices, audio/video devices, and the like. Among other LCD devices, active matrix LCD (“AM-LCD”) devices that employ thin-film transistors (“TFTs”) as switching elements are highly suitable for displaying moving images.

An LCD device realizes an image by adjusting the light transmittance of liquid crystal cells in a liquid crystal panel according to the gray value of a data signal. However, when a direct current (“DC”) voltage is applied to the liquid crystal cells in the liquid crystal panel for an extended period of time, the light transmittance properties of the liquid crystal cells may deteriorate. That is, a DC sticking phenomenon occurs, leading to image sticking in the liquid crystal panel.

To prevent DC sticking, an inversion method has been suggested in which a data voltage supplied to the liquid crystal cells of a display panel is inverted relative to a common voltage. That is, the common voltage is maintained to be a uniform DC voltage, and a voltage with a positive polarity and a voltage with a negative polarity may be alternately applied at intervals of one frame. Also, a dot inversion driving method in which data voltages with different polarities are applied to even pixels that are adjacent within the same frame so as to address problems such as crosstalk and an inversion driving method in which a data voltage is applied to a plurality of pixel groups according to a particular inversion pattern have been suggested.

### SUMMARY

A common voltage may fluctuate due to a ripple phenomenon or a shift phenomenon. Accordingly, even when positive and negative voltages with the same level are respectively applied to two pixels rendering the same color, the pixel to which the positive voltage is applied may have a different gray level from the pixel to which the negative voltage is applied. Particularly, in a case when red (R), green (G), blue (B), and white (W) pixels are set as a unit pixel and inversion driving is performed according to a particular inversion pattern, the distance between a positive pixel and a negative pixel may become greater than in a case when R, G and B pixels are set as a unit pixel. That is, a positive pixel and a negative pixel may render different gray levels when they are not adjacent to each other, and the difference in color between the positive pixel and the negative pixel may become visible to the eye of a user. Accordingly, the quality of display may deteriorate.

Exemplary embodiments of the invention provide a display device which improves the quality of display by preventing the difference in color between a positive pixel and a negative pixel from becoming visible.

However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, a display device is provided. A display device is comprising, a first gate line extending in a first direction, a first pixel column group connected to the first gate line and alternately receiving data voltages with a first polarity pattern and data voltages with a second polarity pattern, which is an inverted polarity pattern of the first polarity pattern, at intervals of unit frames, and a plurality of data lines respectively connected to a plurality of pixels included in the first pixel column group, wherein each of the pixels includes a first sub-pixel to which a first voltage is applied and a second sub-pixel to which a second voltage, which is lower than the first voltage, is applied and a maximum width, in the first direction, of the first sub-pixel is greater than a maximum width, in the first direction, of the second sub-pixel.

In an exemplary embodiment, the first sub-pixel and the second sub-pixel are spatially divided by the first gate line.

In an exemplary embodiment, a first transistor controlling a connection between the first sub-pixel and the first gate line, a second transistor controlling a connection between the second sub-pixel and the first gate line, a plurality of sustain lines extending to correspond to the plurality of data lines and receiving a reference voltage, and a third transistor controlling connections between the plurality of sustain lines and the second sub-pixel.

In an exemplary embodiment, an area of the first sub-pixel is larger than an area of the second sub-pixel.

In an exemplary embodiment, widths of the first sub-pixel and the second sub-pixel gradually increase along a second direction, which is perpendicular to the first direction.

In an exemplary embodiment, the second sub-pixel is triangular and the first sub-pixel is trapezoidal.

In an exemplary embodiment, the first sub-pixel of a first pixel in the first pixel column group overlaps the second sub-pixel of a second pixel neighboring the first pixel along the first direction.

In an exemplary embodiment, the first pixel column group includes a red (R) pixel, a green (G) pixel, a blue (B) pixel, a white (W) pixel, another R pixel, another G pixel, another B pixel, and another W pixel that are sequentially arranged along the first direction.

In an exemplary embodiment, the first polarity pattern is “+−+−−+−+” and the second polarity pattern is “−+−++−+−”.

In an exemplary embodiment, shortest distance, in the first direction, between the first sub-pixel of a positive R pixel and the first sub-pixel of a negative R pixel is shorter than a shortest distance, in the first direction, between the second sub-pixel of the positive R pixel and the second sub-pixel of the negative R pixel.

According to another exemplary embodiment of the invention, a display device is provided. A display device is comprising, a first gate line extending in a first direction, a first pixel column group connected to the first gate line and including at least two first, second, third, and fourth pixels, which render different colors from one another; and a plurality of data lines respectively connected to the pixels included in the first pixel column group, wherein the first pixel column group includes a first sub-group, which has first, second, third, and fourth pixels to which data voltages with a first sub-polarity pattern are applied, and a second sub-group, which has first, second, third, and fourth pixels to which data voltages with a second sub-polarity pattern inverted from the first sub-polarity pattern are applied, each of the pixels included in the first pixel column group includes a first sub-pixel to which a first voltage is applied and a second sub-pixel to which a second voltage, which is lower than the first voltage, is applied, and a shortest distance, in the first direction, between the first sub-pixel of the first pixel of the first sub-group and the first sub-pixel of the first pixel of the second sub-group is shorter than a shortest distance, in the first direction, between the second sub-pixel of the first pixel of the first sub-group and the second sub-pixel of the first pixel of the second sub-group.

In an exemplary embodiment, the first sub-pixel and the second sub-pixel of each of the pixels included in the first pixel column group are spatially divided by the first gate line.

In an exemplary embodiment, a first transistor controlling a connection between the first sub-pixel of each of the pixels included in the first pixel column group and the first gate line, a second transistor controlling a connection between the second sub-pixel of each of the pixels included in the first pixel column group and the first gate line, a plurality of sustain lines extending to correspond to the plurality of data lines and receiving a reference voltage, and a third transistor controlling connections between the plurality of sustain lines and the second sub-pixel of each of the pixels included in the first pixel column group.

In an exemplary embodiment, in each of the pixels included in the first pixel column group, an area of the first sub-pixel is larger than an area of the second sub-pixel.

In an exemplary embodiment, each of the pixels included in the first pixel column group, a maximum width, in the first direction, of the first sub-pixel is greater than a maximum width, in the first direction, of the second sub-pixel.

In an exemplary embodiment, widths of the first sub-pixel and the second sub-pixel of each of the pixels included in the first pixel column group gradually increase along a second direction, which is perpendicular to the first direction.

In an exemplary embodiment, the second sub-pixel of each of the pixels included in the first pixel column group is triangular and the first sub-pixel of each of the pixels included in the first pixel column group is trapezoidal.

In an exemplary embodiment, each of the first and second sub-groups, the first sub-pixel of the first pixel overlaps the second sub-pixel of the second pixel along the first direction.

In an exemplary embodiment, in each of the first and second sub-groups, the first, second, third, and fourth pixels are an R pixel, a G pixel, a B pixel, and a W pixel, respectively, that are sequentially arranged along the first direction.

In an exemplary embodiment, the first sub-polarity pattern is “+−+−” and the second sub-polarity pattern is “−+−+”.

According to the exemplary embodiments, it is possible to prevent a difference in gray level between a positive pixel and a negative pixel from becoming visible to the eye of a user.

Accordingly, it is possible to improve the quality of display.

Other features and exemplary embodiments will be apparent from the following detailed description, the drawings, and the claims.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 is a block diagram illustrating an exemplary embodiment of a display device according to the invention.

FIG. 2 is a plan view illustrating a first pixel column group PX1 of FIG. 1.

FIG. 3 is a plan view illustrating a conventional pixel column group.

FIG. 4 is a plan view illustrating another exemplary embodiment of a first pixel column group of a display device according to the invention.

### DETAILED DESCRIPTION

Advantages and features of the invention and methods of accomplishing the same may be understood more readily by reference to the following detailed description of preferred embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. In an exemplary embodiment, an implanted region illustrated as a rectangle will, typically, have rounded or curved features and/or a gradient of implant concentration at its edges rather than a binary change from implanted to non-implanted region, for example. Likewise, a buried region provided by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which the invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Exemplary embodiments will hereinafter be described with reference to the accompanying drawings.

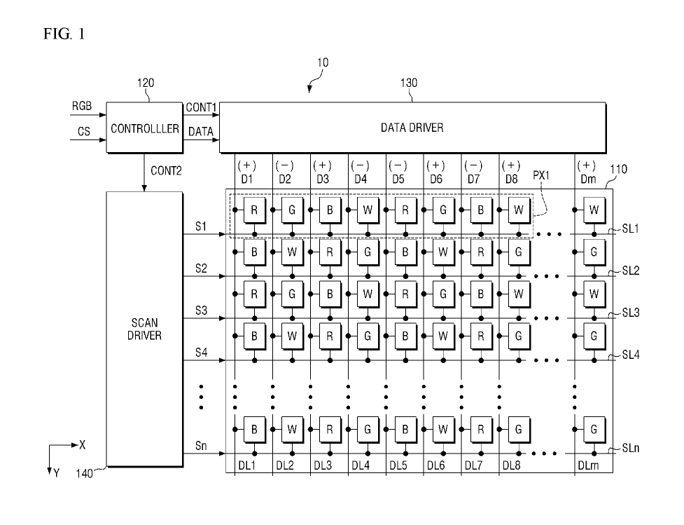

FIG. 1 is a block diagram illustrating a display device according to an exemplary embodiment of the invention.

Referring to FIG. 1, a display device 10 includes a display panel 110, a controller 120, a data driver 130, and a scan driver 140.

The display panel 110 may be a panel for displaying an image. The display panel 110 may include a first substrate, a second substrate, which faces the first substrate, and a liquid crystal layer, which is interposed between the first and second substrates. That is, in an exemplary embodiment, the display panel 110 may be a liquid crystal panel. The first substrate may be an array substrate where a plurality of pixels and lines connected to the pixels are provided, and the second substrate may be an encapsulation substrate which covers the first substrate. A common electrode may be disposed on a surface of the second substrate facing the first substrate. The common electrode may generate a vertical electrical field together with pixel electrodes disposed on the first substrate, and the alignment of liquid crystal molecules in the liquid crystal layer may be controlled according to the electric field. That is, a common voltage may be applied to the common electrode, and a data voltage may be applied to the pixel electrodes, thereby generating an electric field corresponding to the difference between the common voltage and the data voltage in each of the pixels. However, the structure of the display panel 110 is not limited to that set forth herein. That is, the common electrode may be disposed on the first substrate, in which case, the alignment of the liquid crystal molecules may be controlled according to a horizontal electric field generated by the common electrode and the pixel electrodes on the first substrate. The light transmittance of the display panel 110 may be controlled according to the alignment of the liquid crystal molecules, which varies according to an electric field.

The display panel 110 may be connected to a plurality of scan lines SL1, SL2, . . . , SLn, a plurality of data lines DL1, DL2, . . . , DLm, which intersect the scan lines SL1, SL2, . . . , SLn, and the pixels, each of which is connected to one of the scan lines SL1, SL2, . . . , SLn and one of the data lines DL1, DL2, . . . , DLm. As mentioned above, the scan lines SL1, SL2, . . . , SLn, the data lines DL1, DL2, . . . , DLm and the pixels may be disposed on the first substrate of the display panel 110. The pixels may be arranged in a matrix form. The scan lines SL1, SL2, . . . , SLn may extend in a first direction X and may be substantially parallel to one another. The scan lines SL1, SL2, . . . , SLn may include first through n-th scan lines SL1 through SLn, which are sequentially arranged along the second direction Y. The data lines DL1, DL2, . . . , DLm intersect the scan lines SL1, SL2, . . . , SLn. That is, the data lines DL1, DL2, . . . , DLm may extend in a second direction Y, which is perpendicular to the first direction X, and may be substantially parallel to one another.

Each of the pixels may be connected to one of the scan lines SL1, SL2, . . . , SLn and one of the data lines DL1, DL2, . . . , DLm. Each of the pixels may receive one of a plurality of data voltages D1, D2, . . . , Dm via one of the data lines DL1, DL2, . . . , DLm connected thereto according to one of a plurality of scan signals S1, S2, . . . , Sn applied thereto via one of the scan lines SL1, SL2, . . . , SLn connected thereto. That is, each of the pixels may include a transistor, which is turned on by one of the scan signals S1, S2, . . . , Sn and provides one of the data voltages D1, D2, . . . , Dm to a pixel electrode.

In an exemplary embodiment, the controller 120 may receive a control signal CS and an image signal RGB from an external system, for example. The image signal RGB may include luminance information relating to each of the pixels. In an exemplary embodiment, luminance may have a predefined number of gray levels, for example, 1024, 256 or 64 gray levels, for example. Examples of the control signal CS may include a vertical synchronization signal Vsync, a horizontal synchronization signal Hsync, a data enable signal DE, and a clock signal CLK, for example. The controller 120 may generate first and second driving control signals CONT1 and CONT2 and image data DATA based on the image signal RGB and the control signal CS. More specifically, the controller 120 may generate the image data DATA by dividing the image signal RGB in units of frames according to the vertical synchronization signal Vsync and dividing the image signal RGB in units of the scan lines SL1, SL2, . . . , SLn according to the horizontal synchronization signal Hsync. The controller 120 may provide the first driving control signal CONT1 and the image data DATA to the data driver 130. The controller 120 may compensate for the image data DATA and may provide the compensated image data to the data driver 130. The controller 120 may provide the second driving control signal CONT2 to the scan driver 140.

The scan driver 140 may be connected to the display panel 110 via the scan lines SL1, SL2, . . . , SLn. The second driving control signal CONT2 may be a signal for controlling the output of the scan signals S1, S2, . . . , Sn. Examples of the second driving control signal CONT2 may include a gate start pulse, a gate shift clock and a gate output enable signal. The scan driver 140 may include a plurality of gate driver integrated circuits (“ICs”), and the gate start pulse may be applied to a gate driver IC that is to generate a first gate pulse and may thus control the corresponding gate driver IC to generate a first gate pulse. In an exemplary embodiment, the gate shift clock may be a clock signal applied in common to the gate driver ICs and may shift the gate start pulse. The gate output enable signal may control the output of the gate driver ICs. The scan driver 140 may sequentially apply the scan signals S1, S2, . . . , Sn to the scan lines SL1, SL2, . . . , SLn, respectively.

In an exemplary embodiment, the data driver 130 may include a shift register, a latch and a digital-to-analog converter (“DAC”), for example. The data driver 130 may receive the first driving control signal CONT1 and the image data DATA from the controller 120. Examples of the first driving control signal CONT1 may include a source start pulse, a source sampling clock, a polarity control signal, and a source output enable signal. The source start pulse may control the start timing of data sampling of the data driver 130. The source sampling clock may be a clock signal that controls the timing of data sampling of the data driver 130 in accordance with a rising or falling edge thereof. The data driver 130 may include a plurality of source driver ICs, and the polarity control signal may control the timing of data voltages sequentially output from the data driver ICs. The source output enable signal may control the output timing of the data driver 130.

The data driver 130 may latch the image data DATA according to the first control signal CONT1 and may convert the latch data into an analog positive/negative gamma compensation voltage so as to supply the data voltages D1, D2, . . . , Dm to the data lines DL1, DL2, . . . , DLm, respectively, whose polarity is inverted at intervals of a predetermined period, via a plurality of output channels. The output channels may be respectively connected to the data lines DL1, DL2, . . . , DLm. The polarity of data voltages output from the same output channel may be inverted in units of frames. In an exemplary embodiment, the data voltages D1, D2, . . . , Dm provided by the data driver 130 during a frame may have a particular polarity pattern, and the particular polarity pattern may be repeated in units of pixel column groups.

As illustrated in FIG. 1, a plurality of pixels connected to the first gate line SL1 may be defined as a first pixel column group PX1. In an exemplary embodiment, the first pixel column group PX1 may include eighth pixels, for example, but the invention is not limited thereto. In another exemplary embodiment, the first pixel column group PX1 may include a different number of pixels. Data voltages with a first polarity pattern and data voltages with a second polarity pattern, which is an inverted polarity pattern of the first polarity pattern, may be applied to the first pixel column group PX1 at intervals of unit frames. In an exemplary embodiment, the first polarity pattern may be “+−+−−+−+”, and the second polarity pattern may be “−+−++−+−”, for example, wherein “+” may denote a data voltage higher than a common voltage and “−” may denote a data voltage lower than the common voltage. The liquid crystal layer may be controlled according to the difference between a data voltage and the common voltage. The first polarity pattern may be a polarity pattern for reducing smears by preventing a shift of the common voltage, compared to a dot inversion method in which the polarity of data voltages is inverted in units of pixels. The pixels connected to the first gate line SL1 may include multiples of the first pixel column group PX1. That is, the pixels connected to the first gate line SL1 may be provided with data voltages with a repeating polarity pattern, i.e., “+−+−−+−+”, according to the first scan signal S1. However, the invention is not limited thereto, and the pixels connected to the first gate line SL1 may be provided with data voltages with various other repeating polarity patterns, e.g., “−+−++−+−”, according to the first scan signal S1, for example. Pixel column groups connected to the other scan lines, i.e., the second through n-th scan lines SL2 through SLn, may be provided with data voltages with the same polarity pattern as the data voltages applied to the first gate line SL1, but the invention is not limited thereto. That is, a column inversion scheme may be employed in which the pixels connected to the first gate line SL1 are provided with data voltages with a polarity pattern inverted from the polarity pattern of data voltages applied to pixels connected to the second gate line SL2, which is subsequent to the first gate line SL1, and pixels connected to the third gate line SL3 are provided with data voltages with the polarity pattern inverted from the polarity pattern of the data voltages applied to pixels connected to the second gate line SL2. That is, the data voltages applied to the third gate line SL3 may have the same polarity pattern as the data voltages applied to the first gate line SL1.

In the first column group PX1, first, second, third, and fourth pixels, which render different colors from one another, may be sequentially arranged at least twice. As illustrated in FIG. 1, the first pixel column group PX1 may include a total of eight pixels, i.e., a first pixel, a second pixel, a third pixel, a fourth pixel, another first pixel, another second pixel, another third pixel, and another fourth pixel. In an exemplary embodiment, first pixels, second pixels, third pixels, and fourth pixels may be red (R) pixels, green (G) pixels, blue (B) pixels, and white (W) pixels, respectively, for example, but the invention is not limited thereto. That is, the colors rendered by first pixels, second pixels, third pixels, and fourth pixels and the order of the arrangement of first pixels, second pixels, third pixels, and fourth pixels are not limited to the example illustrated in FIG. 1. R pixels may be pixels in which a red color filter is disposed above or below a pixel electrode (not illustrated), and may emit R light. G pixels may be pixels emitting G light due to the presence of a G color filter therein, and B pixels may be pixels emitting B light due to the presence of a B color filter therein. W pixels may be pixels with no color filter disposed therein or with a transparent color filter disposed therein, and may emit W light. That is, the first pixel column group PX1 may include a plurality of pixels that are arranged in the order of R, G, B, W, R, G, B, and W, for example. Also, the pixels connected to the first gate line SL1 may be repeatedly arranged in the order of R, G, B, W, R, G, B, and W, for example. The pixels connected to the second gate line SL2, which is subsequent to the first gate line SL1, may be arranged in a different order from the pixels connected to the first gate line SL1. That is, in order to prevent the degradation of the quality of display that may be caused by “color attraction”, the pixels connected to the second gate line SL2 may be repeatedly arranged in the order of B, W, R, G, B, W, R, and G, for example, but the invention is not limited thereto. The aforementioned and other descriptions of the first pixel column group PX1 may directly apply to the other pixels of the display device 10.

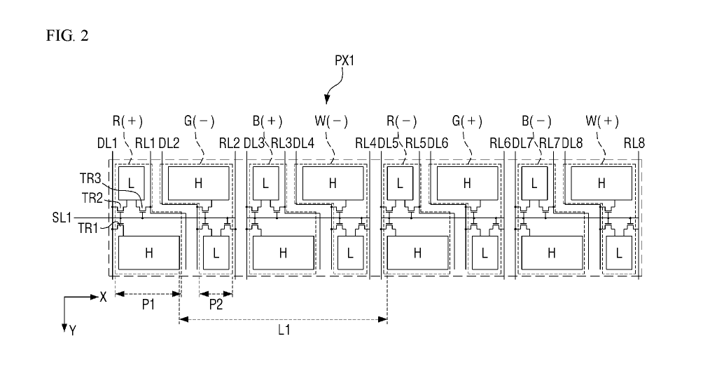

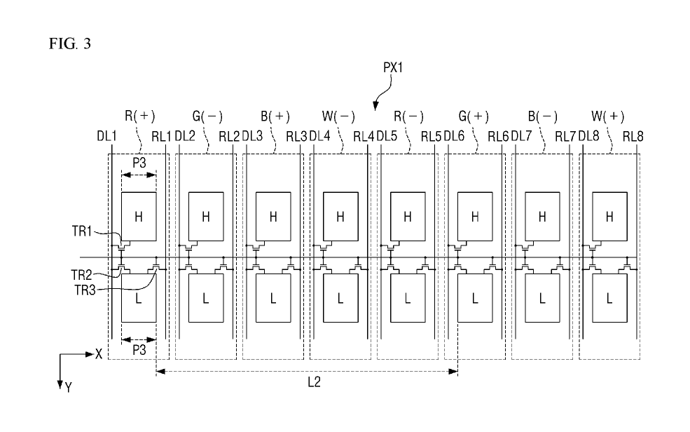

According to the aforementioned pixel arrangement and data voltage polarity patterns, the first pixel column group PX1 may include a positive R pixel (R+), a negative G pixel (G−), a positive B pixel (B+), a negative W pixel (W−), a negative R pixel (R−), a positive G pixel (G+), a negative B pixel (B−), and a positive W pixel (W+), for example. A positive data voltage and a negative data voltage may have the same level with reference to the common voltage, but in reality, result in different luminances due to a ripple and shift of the common voltage. That is, the positive R pixel (R+) and the negative R pixel (R−), the positive G pixel (G+) and the negative G pixel (G−), the positive B pixel (B+) and the negative B pixel (B−), or the positive W pixel (W+) and the negative W pixel (W−) may have different luminances from each other. Since between two pixels of the same color, but of the opposite polarities, for example, between the positive R pixel (R+) and the negative R pixel (R−), three pixels of different colors from the two pixels of the opposite polarities, i.e., the negative G pixel (G−), the positive B pixel (B+) and the negative white pixel (W−), are arranged, the difference in luminance between the two pixels of the opposite polarities may become easily visible to the eye of a user, and as a result, the quality of display may be degraded. However, the display device 10 includes a pixel structure which minimizes the distance between the two pixels of the opposite polarities, i.e., the distance between the positive R pixel (R+) and the negative R pixel (R−), and thus prevents the difference in luminance between the positive R pixel (R+) and the negative R pixel (R−) from becoming visible, for example. The pixel structure of the display device 10 will hereinafter be described with reference to FIGS. 2 and 3.

FIG. 2 is a plan view illustrating the first pixel column group PX1 of FIG. 1, and FIG. 3 is a plan view illustrating a conventional pixel column group.

Referring to FIGS. 2 and 3, the first pixel column group PX1 may include eight pixels, i.e., a positive R pixel (R+), a negative G pixel (G−), a positive B pixel (B+), a negative W pixel (W−), a negative R pixel (R−), a positive G pixel (G+), a negative B pixel (B−), and a positive W pixel (W+), for example. The polarity pattern of data voltages applied to the first pixel column group PX1, i.e., “+−+−−+−+”, may include a first sub-polarity pattern, i.e., “+−+−”, and a second sub-polarity pattern, i.e., “−+−+”, for example. The pixels included in the first pixel column group PX1 may include a first sub-group to which data voltages with the first sub-polarity pattern are applied and a second sub-group to which data voltages with the second sub-polarity pattern are applied. That is, the pixels included in the first sub-group may be respectively identical to the pixels included in the second sub-group, but may be distinguished from the pixels included in the second sub-group by the polarities of data voltages applied thereto. The first sub-group may include first, second, third, and fourth pixels, i.e., a positive R pixel (R+), a negative G pixel (G−), a positive B pixel (B+), a negative W pixel (W−), and the second sub-group may include fifth through eighth pixels, i.e., a negative R pixel (R−), a positive G pixel (G+), a negative B pixel (B−), and a positive W pixel (W+). As mentioned above, the pixels of the first sub-group may respectively receive a data voltage of an opposite polarity from, and thus have a different luminance from, the pixels of the second sub-group.

Each of the pixels of the first pixel column group PX1 may include a first sub-pixel H and a second sub-pixel L. A first voltage may be applied to the first sub-pixel H, and a second voltage, which is lower than the first voltage, may be applied to the second sub-pixel L. The first voltage may be a high voltage, which is higher than an input voltage corresponding to the image signal RGB, and the second voltage may be a low voltage, which is lower than the input voltage corresponding to the image signal RGB. Each of the pixels of the first pixel column group PX1 may display a luminance value corresponding to the image signal RGB by combining the luminance rendered by the first sub-pixel H to which the first voltage is applied and the luminance rendered by the second sub-pixel L to which the second voltage is applied. That is, the display device 10 may perform a division driving operation that divides each of the pixels of the first pixel column group PX1 into a plurality of spaces.

Each of the pixels of the first pixel column group PX1 may include a first transistor TR1, which connects the first sub-pixel H and the first gate line SL1, a second transistor TR2, which connects the second sub-pixel L and the first gate line SL1, one of a plurality of sustain lines RL1, RL2, . . . , RLm to which a reference voltage is applied, and a third transistor TR3, which connects one of the sustain lines RL1, RL2, . . . , RLm and the second sub-pixel L. The first sub-pixel H and the second sub-pixel L may receive a data voltage via one of the data lines DL1, DL2, . . . , DLm according to a scan signal provided thereto via the first gate line SL1. The second sub-pixel L may be connected to one of the sustain lines RL1, RL2, . . . , RLm via the third transistor TR3 that is turned on by a scan signal. Accordingly, a voltage applied to the second sub-pixel L may be divided by the sustain line to which the second sub-pixel L is connected, and the second sub-pixel L may be charged with the second voltage, which is lower than the first voltage that the first sub-pixel H is charged with. During the division driving operation, liquid crystal molecules corresponding to the first sub-pixel H and liquid crystal molecules corresponding to the second sub-pixel L may rotate at different angles from each other, thereby improving viewing angle properties.

The first sub-pixel H, which displays a high luminance value, and the second sub-pixel L, which displays a low luminance value, may have different maximum widths in the first direction X. In an exemplary embodiment, a maximum width P1, in the first direction X, of the first sub-pixel H may be greater than a maximum width P2, in the first direction X, of the second sub-pixel L. In an exemplary embodiment, the maximum width P1 of the first sub-pixel H may be substantially twice as large as the maximum width P2 of the second sub-pixel L, for example, but the invention is not limited thereto. In an exemplary embodiment, the first sub-pixel H and the second sub-pixel L may have substantially the same width in the second direction Y, which is perpendicular to the first direction X. Each of the pixels of the first pixel column group PX1 may include the first sub-pixel H and the second sub-pixel L. In an exemplary embodiment, the first sub-pixel H and the second sub-pixel L may have a rectangular shape, and have different areas from each other, and the horizontal width of the second sub-pixel L may be smaller than the horizontal width of the first sub-pixel H, for example. In an exemplary embodiment, the area of the first sub-pixel H may be larger than the area of the second sub-pixel L, for example. The first sub-pixel H and the second sub-pixel L of the first pixel (R+) of the first pixel column group PX1 may have the same areas as the first sub-pixel H and the second sub-pixel L, respectively, of the second pixel (G−) of the first pixel column group PX1, but the pattern of the arrangement of the first sub-pixel H and the second sub-pixel L in the first pixel (R+) may be opposite to the pattern of the arrangement of the first sub-pixel H and the second sub-pixel L in the second pixel (G−). The first sub-pixel H of the first pixel (R+) may overlap the second sub-pixel L of the second pixel (G−) along the first direction X. That is, the first sub-pixel H of the first pixel (R+) may be arranged side-by-side with the second sub-pixel L of the second pixel (G−) along the first direction X. The second sub-pixel L of the first pixel (R+) may overlap the first sub-pixel H of the second pixel (G−) along the first direction X. That is, the second sub-pixel L of the first pixel (R+) may be arranged side-by-side with the first sub-pixel H of the second pixel (G−) along the first direction X. That is, the first pixel (R+) may be L-shaped, and the second pixel (G−) may be inverse L-shaped. Odd-numbered pixels in the first pixel column group PX1 may have the same structure as the first pixel (R+), and even-numbered pixels in the first pixel column group PX2 may have the same structure as the second pixel (G−). That is, the first, third, fifth, and seventh pixels (R+, B+, R−, and B−) may be L-shaped, and the second, fourth, sixth, and eighth pixels (G−, W−, G+ and W+) may be inverse L-shaped, for example. Accordingly, a distance L1 between the first sub-pixel H of the first pixel (R+) and the first sub-pixel H of the fifth pixel (R−) may be smaller than a distance between the second sub-pixel L of the first pixel (R+) and the second sub-pixel L of the fifth pixel (R−). A shortest distance, in the first direction X, between the first sub-pixel H of the first pixel (R+) of the first sub-group and the first sub-pixel H of the first pixel (R−) of the second sub-group may be smaller than a shortest distance, in the first direction X, between the second sub-pixel L of the first pixel (R+) of the first sub-group and the second sub-pixel L of the first pixel (R−) of the second sub-group. The distance relationship between the first pixel (R+) of the first sub-group and the first pixel (R−) of the second sub-group may directly apply to the second pixel of the first sub-group and the second pixel of the second sub-group, the third pixel of the first sub-group and the third pixel of the second sub-group, or the fourth pixel of the first sub-group and the fourth pixel of the second sub-group.

The visibility of luminance differences between the pixels of the first sub-group and the pixels of the second sub-group may be determined by the first sub-pixel H of each of the pixels of the first pixel column group PX1. According to the illustrated exemplary embodiment, the distance L1 between the first sub-pixels H of two identical pixels from different sub-groups of the first pixel column group PX1 may be reduced, compared to the structure of a conventional pixel row group. More specifically, the distance L1 between the first sub-pixel H of the first pixel (R+) and the first sub-pixel H of the fifth pixel (R−) of the exemplary embodiment may be shorter than a distance L2 between the first sub-pixel H of the first pixel (R+) and the first sub-pixel H of the fifth pixel (R−) of a first pixel column group PX1 of a conventional display device where a first sub-pixel H and a second sub-pixel L of each pixel have the same width P3 in the first direction X. Since the first pixel (R+) and the fifth pixel (R−) of the first pixel column group PX1 of the display device 10 are relatively close to each other, any difference in luminance therebetween may not be easily visible to the eye of a user. Thus, the degradation of the quality of display may be prevented.

A display device according to another exemplary embodiment of the invention will hereinafter be described.

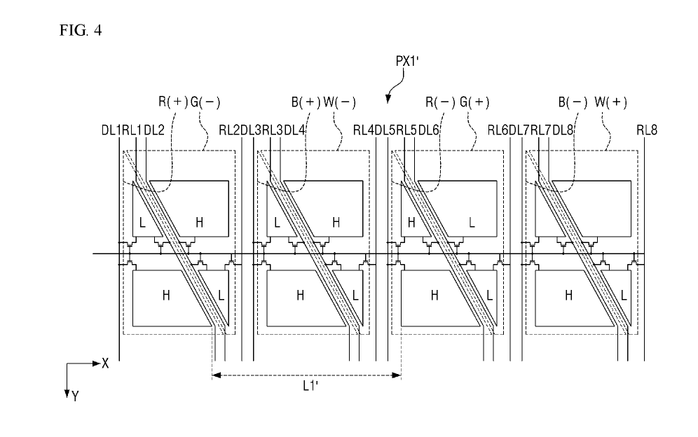

FIG. 4 is a plan view illustrating a first pixel column group of a display device according to another exemplary embodiment of the invention. In the previous and present exemplary embodiments, like reference numerals indicate like elements, and thus, descriptions thereof will be omitted or at least simplified.

Referring to FIG. 4, a first pixel column group PX1′ may include eight pixels, i.e., a positive R pixel (R+), a negative G pixel (G−), a positive B pixel (B+), a negative W pixel (W−), a negative R pixel (R−), a positive G pixel (G+), a negative B pixel (B−), and a positive W pixel (W+), for example. In an exemplary embodiment, the polarity pattern of data voltages applied to the first pixel column group PX1′, i.e., “+−+−−+−+”, may include a first sub-polarity pattern, i.e., “+−+−”, and a second sub-polarity pattern, i.e., “−+−+”, for example. The pixels included in the first pixel column group PX1′ may be divided into a first sub-group to which data voltages with the first sub-polarity pattern are applied and a second sub-group to which data voltages with the second sub-polarity pattern are applied. That is, pixels included in the first sub-group may be respectively identical to pixels included in the second sub-group, but the polarity of data voltages applied to the pixels included in the first sub-group may differ from the polarity of data voltages applied to the pixels included in the second sub-group. In an exemplary embodiment, the first sub-group may include first, second, third, and fourth pixels, i.e., a positive R pixel (R+), a negative G pixel (G−), a positive B pixel (B+), a negative W pixel (W−), and the second sub-group may include fifth through eighth pixels, i.e., a negative R pixel (R−), a positive G pixel (G+), a negative B pixel (B−), and a positive W pixel (W+), for example. The pixels of the first sub-group may respectively receive a data voltage of an opposite polarity from, and thus have a different luminance from, the pixels of the second sub-group.

Each of the pixels of the first pixel column group PX1′ may include a first sub-pixel H and a second sub-pixel L. A first voltage may be applied to the first sub-pixel H, and a second voltage, which is lower than the first voltage, may be applied to the second sub-pixel L. Each of the pixels of the first pixel column group PX1′ may display a luminance value corresponding to an image signal by combining the luminance rendered by the first sub-pixel H to which the first voltage is applied and the luminance rendered by the second sub-pixel L to which the second voltage is applied. The first sub-pixel H, which displays a high luminance value, and the second sub-pixel L, which displays a low luminance value, may have different maximum widths in the first direction X. A maximum width P1, in the first direction X, of the first sub-pixel H may be greater than a maximum width P2, in the first direction X, of the second sub-pixel L. In the illustrated exemplary embodiment, the width, in the first direction X, of the first sub-pixel H and the width, in the first direction X, of the second sub-pixel L may gradually increase along a second direction Y, which is perpendicular to the first direction X. That is, in an exemplary embodiment, the second sub-pixel L may be triangular, and the first sub-pixel H may be trapezoidal, for example. Accordingly, a distance L1′ between the first sub-pixel H of the first pixel (R+) and the first sub-pixel H of the fifth pixel (R−) may be much shorter in the display device according to the illustrated exemplary embodiment than in a conventional display device. Since the first pixel (R+) and the fifth pixel (R−) of the first pixel column group PX1′ are close to each other, any difference in luminance therebetween may not be easily visible to the eye of a user. Thus, the degradation of the quality of display may be prevented.

However, the effects of the invention are not restricted to the one set forth herein. The above and other effects of the invention will become more apparent to one of daily skill in the art to which the invention pertains by referencing the claims.

While the invention has been particularly shown and described with reference to exemplary embodiments thereof, it will be understood by those of ordinary skill in the art that various changes in provide and detail may be made therein without departing from the spirit and scope of the invention as defined by the following claims. The exemplary embodiments should be considered in a descriptive sense only and not for purposes of limitation.

What is claimed is:

1. A display device, comprising:
a first gate line extending in a first direction;
a first pixel column group which includes a plurality of pixels connected to the first gate line and alternately receiving data voltages with a first polarity pattern and data voltages with a second polarity pattern, which is an inverted polarity pattern of the first polarity pattern, at an interval of a unit of a frame; and
a plurality of data lines respectively connected to the plurality of pixels,
wherein each of the plurality of pixels includes a first sub-pixel to which a first voltage is applied and a second sub-pixel to which a second voltage, which is lower than the first voltage, is applied and a maximum width, in the first direction, of the first sub-pixel is greater than a maximum width, in the first direction, of the second sub-pixel.

2. The display device of claim 1, wherein the first sub-pixel and the second sub-pixel are spatially divided by the first gate line.

3. The display device of claim 2, further comprising:
a first transistor which controls a connection between the first sub-pixel and the first gate line;
a second transistor which controls a connection between the second sub-pixel and the first gate line;
a plurality of sustain lines extending to correspond to the plurality of data lines and receiving a reference voltage; and
a third transistor which controls connections between the plurality of sustain lines and the second sub-pixel.

4. The display device of claim 2, wherein an area of the first sub-pixel is larger than an area of the second sub-pixel.

5. The display device of claim 1, wherein widths of the first sub-pixel and the second sub-pixel gradually increase along a second direction, which is perpendicular to the first direction.

6. The display device of claim 5, wherein the second sub-pixel has a triangular shape, and the first sub-pixel has a trapezoidal shape.

7. The display device of claim 1, wherein the first sub-pixel of a first pixel in the first pixel column group overlaps the second sub-pixel of a second pixel neighboring the first pixel along the first direction.

8. The display device of claim 1, wherein the first pixel column group includes a red (R) pixel, a green (G) pixel, a blue (B) pixel, a white (W) pixel, another red (R) pixel, another green (G) pixel, another blue (B) pixel, and another white (W) pixel which are sequentially arranged along the first direction.

9. The display device of claim 8, wherein the first polarity pattern is “+−+−−+−+” and the second polarity pattern is “−+−++−+−” sequentially in the first direction.

10. The display device of claim 9, wherein a shortest distance, in the first direction, between the first sub-pixel of a positive R pixel and the first sub-pixel of a negative R pixel is shorter than a shortest distance, in the first direction, between the second sub-pixel of the positive R pixel and the second sub-pixel of the negative R pixel.

11. A display device, comprising:
a first gate line extending in a first direction;
a first pixel column group connected to the first gate line and including at least two first, second, third, and fourth pixels, the at least two first, second, third, and fourth pixels render different colors from one another; and
a plurality of data lines respectively connected to the at least two first, second, third, and fourth pixels included in the first pixel column group,
wherein the first pixel column group includes a first sub-group, which includes first, second, third, and fourth pixels of the at least two first, second, third, and fourth pixels to which data voltages with a first sub-polarity pattern are applied, and a second sub-group, which includes first, second, third, and fourth pixels of the at least two first, second, third, and fourth pixels to which data voltages with a second sub-polarity pattern inverted from the first sub-polarity pattern are applied, each of the first, second, third, and fourth pixels included in the first pixel column group includes a first sub-pixel to which a first voltage is applied and a second sub-pixel to which a second voltage, which is lower than the first voltage, is applied, and a shortest distance, in the first direction, between the first sub-pixel of the first pixel of the first sub-group and the first sub-pixel of the first pixel of the second sub-group is shorter than a shortest distance, in the first direction, between the second sub-pixel of the first pixel of the first sub-group and the second sub-pixel of the first pixel of the second sub-group.

12. The display device of claim 11, wherein the first sub-pixel and the second sub-pixel of each of the pixels included in the first pixel column group are spatially divided by the first gate line.

13. The display device of claim 12, further comprising:
a first transistor which controls a connection between the first sub-pixel of each of the pixels included in the first pixel column group and the first gate line;
a second transistor which controls a connection between the second sub-pixel of each of the pixels included in the first pixel column group and the first gate line;
a plurality of sustain lines extending to correspond to the plurality of data lines and receiving a reference voltage; and
a third transistor which controls connections between the plurality of sustain lines and the second sub-pixel of each of the pixels included in the first pixel column group.

14. The display device of claim 12, wherein in each of the pixels included in the first pixel column group, an area of the first sub-pixel is larger than an area of the second sub-pixel.

15. The display device of claim 11, wherein in each of the pixels included in the first pixel column group, a maximum width, in the first direction, of the first sub-pixel is greater than a maximum width, in the first direction, of the second sub-pixel.

16. The display device of claim 15, wherein widths of the first sub-pixel and the second sub-pixel of each of the pixels included in the first pixel column group gradually increase along a second direction, which is perpendicular to the first direction.

17. The display device of claim 16, wherein the second sub-pixel of each of the pixels included in the first pixel column group has a triangular shape, and the first sub-pixel of each of the pixels included in the first pixel column group has a trapezoidal shape.

18. The display device of claim 11, wherein in each of the first and second sub-groups, the first sub-pixel of the first pixel overlaps the second sub-pixel of the second pixel along the first direction.

19. The display device of claim 11, wherein in each of the first and second sub-groups, the first, second, third, and fourth pixels are an R pixel, a G pixel, a B pixel, and a W pixel, respectively, which are sequentially arranged along the first direction.

20. The display device of claim 19, wherein the first sub-polarity pattern is “+−+−” and the second sub-polarity pattern is “−+−+” sequentially in the first direction.
